(19) United States
(12) Patent Application Publication
(10) Pub. No.: US 2007/0294098 A1
(43) Pub. Date: Dec. 20, 2007

(54) System and Method For Implementing An Occurrence Reporting system

(76) Inventors: Sonya Angela Tietjen, West Vancouver (CA); Gregory Frank Wyght, Surrey (CA); Robert Michael Meaney, St. John's (CA)

Correspondence Address: GOWLING LAFLEUR HENDERSON LLP (OTT), SUITE 2600, 160 ELGIN STREET, OTTAWA, ON, K1P1C3, CA

(21) Appl. No.: 11/691,490

(22) Filed: Mar. 26, 2007

Related U.S. Application Data
(60) Provisional application No. 60/785,368, filed on Mar. 24, 2006.

(51) Int. Cl. G06Q 50/00

(52) U.S. Cl. 705/1

(57) ABSTRACT

The invention comprises a computer network for gathering information in a multi-user environment in order to manage, monitor and report occurrence information. The information includes input such as data representing an event that is either unsafe, caused or could have caused harm to people, property and/or the environment or any unsafe act or condition that has the potential to cause harm to people, property and/or the environment. Apparatus is provided for storing and retrieving these inputs from a database as well as printing them in predetermined formats. Apparatus is also provided for determining whether the input requires corrective action to be taken and if so generating a request for corrective action and verifying that appropriate corrective action is taken.

### CROSS REFERENCE TO RELATED APPLICATIONS

This application claims the benefit of U.S. Provisional patent application Ser. No. 60/785368, filed Mar. 24, 2006, the disclosure of which is incorporated herein by reference.

### FIELD OF THE INVENTION

The invention relates to the field of safety management systems, and in particular to a tool and method for use with safety management system for collecting, monitoring and collaborating on data collected in the form of reports, the reports including data related to one of more safety related occurrences in an enterprise.

### BACKGROUND OF THE INVENTION

Many industries require systems to manage safety and quality of their operations and to provide administrative functions related to audits of the safety and quality of their operations. This requirement is usually not just mandated by regulations but also by company management and is particularly important in industries that involve potential risk to the public. Such industries include civil aviation companies that provide aircraft leasing, aircraft operation, maintenance and training related to large numbers of aircraft.

A safety related occurrence or simply an occurrence generally means an operational interruption, defect, fault or other irregular circumstance that has or may have influenced flight safety and that may or may not have resulted in an accident or serious incident. In some instances an occurrence includes an event which endangers or which, if not corrected, would endanger an aircraft, its occupants or any other person. In other instances an occurrence may also include an accident that has already occurred. Thus to enhance the safety of civil aviation, better knowledge of occurrences is required in order to facilitate analysis and prevent accidents. Occurrence reports (sometimes called safety reports) are typically collected, evaluated, processed and stored in a database.

Reducing the severity of an incident that may put the public at risk or preventing its occurrence is an important goal of a safety management system. This may be achieved by efficient pooling of data and resources to capitalize on the information gathered to improve the ability of the company to analyze the data allowing a more proactive approach to managing safety.

Furthermore, these companies are frequently required to comply with rules or regulations imposed by the jurisdictions that they operate in. The problem is further exacerbated if the company is a large multinational that operates in different regulatory jurisdictions. In the civil aviation industry safety management systems are important. Various jurisdictions have committed to the implementation of safety management systems in aviation organizations. At the most fundamental level the aim of these regulations is to improve safety through pro-active management rather than reactive compliance with regulatory requirements.

Large organisations have a need to manage safety related information between various business units and various levels of employees, ranging from general employees, safety and quality (S&Q) managers, departmental managers to division managers and even customers. If all employees or staff have the ability to submit safety related reports with the assurance that each will be addressed, this information becomes a pool of information between all business units within the organisation that can be shared and compared so as to generate new ideas about safety management or improve best practices. However current safety systems seem to be lacking in that it has been found that even if the company or its employees or associates wish to comply with the rules and regulations as it relates to occurrence reports, they may not be adequately informed about the steps required to identify the characteristics, or criteria required to report occurrences. Also employees may not be willing to participate if they feel a lack of transparency in the reporting process or a culture of blame for reporting issues and thus consider the process ineffective.

Accordingly there is a need for an occurrence reporting data system that provides easy access and transparency of information, so that the number of reports submitted to the system will increase. This increase in reporting and hence information available to managers will allow the implementation of preventative processes or actions to decrease the severity of future occurrences.

A traditional method of implementing the reporting of occurrences is through a paper-based and manual system. However, often the paper medium that is used to document or disseminate the knowledge of the applicable occurrences only recorded in a fixed form, has limited access, is irregularly updated, and is cumbersome to utilize in the field. Some system have been implemented as primitive stand alone database systems, however non of these systems provide corporate wide system that takes into account the complex and sometimes competing requirements such as a large multinational civil aviation company.

Ensuring employee participation in the safety management system procedures, raising awareness about hazards increasing confidence in reporting and involvement in the analysis and classification of human factors events is one of the goals of a safety aware company.

Accordingly, there is a need for a system and method that advances some of the goals and mitigates some of the above disadvantages.

### SUMMARY OF THE INVENTION

The invention comprises a computer network for gathering information in a multi-user environment in order to manage, monitor and report occurrence information. The information includes input such as data representing an event that is either unsafe, caused or could have caused harm to people, property and/or the environment or any unsafe act or condition that has the potential to cause harm to people, property and/or the environment. Apparatus is provided for storing and retrieving these inputs from a database as well as printing them in predetermined formats. Apparatus is also provided for allowing trained personnel to determine whether the input requires corrective action to be taken and if so generating a request for corrective action and verifying that appropriate corrective action is taken.

In accordance with another embodiment of this invention there is provided a method for implementing an occurrence reporting tool, the method comprising the steps of:

a. inputting at least one safety related occurrence data;

b. determining whether said input occurrence requires corrective action;

c. generating a request for corrective action if said occurrence is determined to require corrective action; and

d. continuing to generate said request for corrective action until appropriate corrective action is taken.

The system provides advantages of closed loop occurrence reporting, an auditing data pool, corrective and preventative action tracking, S&Q performance measurement, KPI data collection for other departments as appropriate, ISO requirements compliance as appropriate (i.e. Customer Feedback, etc.), S&Q information trend analysis tools, S&Q reporting to authorities tools, Corporate communication as appropriate (i.e. Weekly Reports, meeting minutes, etc.), risk assessment and other reports depository, and capitalizing on best practices among divisions.

### BRIEF DESCRIPTION OF THE DRAWINGS

Embodiments of the present matter will be described, by way of example only, with reference to the attached figures, wherein:

FIG. 1 is a diagram of an occurrence reporting tool deployed in a network according to an embodiment of the present invention;

FIG. 2 is a block diagram of the architecture of the occurrence reporting tool;

FIGS. 3a and 3b show respectively a context diagram and database relationship for the occurrence reporting system;

FIG. 4 is a schematic diagram of a general occurrence reporting process according to an embodiment of the invention;

FIG. 5 is a screen display of a preliminary risk rating chart;

FIG. 6 is a screen display of a summary report;

FIG. 7 is process for recording a meeting;

FIG. 8 shows another embodiment of an occurrence reporting process;

FIG. 9 is a process for customer feedback;

FIG. 10 is a process for reporting investigations; and

FIG. 11 is a process for CPA's.

### DETAILED DESCRIPTION OF PREFERRED EMBODIMENTS

In the following description like numerals refer to like structures in the drawings.

The occurrence reporting system according to the present invention is a tool to manage, monitor and report safety and quality information in a civil aviation environment. The system has a number of functions:

To manage information between various levels of employees at a large civil aviation organization, having multiple business units and divisions. These include all staff, staff having the designation of safety and quality managers, and other department managers, such as (i.e., operations, technical services etc.;

To provide all employees with the ability to enter safety and quality related reports with the assurance that each will be addressed. The system ensures that reports cannot be inadvertently or deliberately deleted. This includes all accident, incidents, operational occurrences, technical defects, operational deficiencies, dangerous actions and conditions, and personal injuries as per the applicable National Airworthiness Authorities (NAA) and national and/or local HESS regulations;

To allow management, if necessary, to initiate relevant investigation based on the reports, and also inform the applicable authority according to the requirements for immediate information. Furthermore, the reports shall be used for information, lessons learned and recommendations for continuous improvement;

A method of communication between bases and regional managers by having weekly SITREPs (Situational Reports) entered by the base managers;

Collection of key performance(KP) data world wide;

Repository and management of customer feedback information world wide; and

Trend analysis and reporting tools for S&Q information.

The system ensures that information entered becomes a pool of information between all divisions and business units allowing report and data comparisons, sharing of ideas and best practices.

Through easy access to the system and transparency of information, the goal is to increase the number of reports submitted to the system. With an increase of information available to the managers, the result will be the ability to decrease the severity of occurrences.

The system may be operated wholly in-house, operated thorough a remote application service provider in communication with the company, or some combination thereof. The system permits access by authorized users or representatives specified by the company.

The occurrence report system is a tool for any employee to write up any kind of occurrence, including reportable occurrences - required by the NAA in the country of operation or the company to be reported, any hazardous situation that occurred while operating the aircraft. The S&Q manager, in consultation with the regional directors, will report the required occurrences to the authorities.

All occurrence reports are entered and directed to the appropriate people and ensures that the observations in the report are considered and responded to. The system provides management the information necessary to determine when to initiate an investigation of an occurrence. The primary goal of the investigation is to prevent recurrence.

Occurrence reports are either reactive or proactive. A reactive report is used to report an event that has already happened. These reports include an event that is either unsafe, caused or could have caused harm to people, property and/or the environment. A proactive report is used to report any unsafe act or condition that in the submitter's opinion has the potential to cause harm to people, property and/or the environment.

The following are identified as occurrence reports:

Flight Occurrence—used to report any occurrence including ground operations before and after flight while the aircraft is under the control of the operations staff (may include: Dangerous goods, HESS, Airprox and Bird Strike)

Ground Occurrence—used to report any occurrence related to ground operations related to aircraft or events on the ramp any time ground operations has responsibility for the aircraft (may include: Dangerous goods, HESS)

Hazard identification—any action or condition that is contrary to company accepted policies or procedures, where in the opinion of the employee, passenger or visitor there has been a potential risk for damage to equipment personnel or environment.

HESS—health, environment, safety and security (meets the local requirements for reporting under AOSH)•Non-conformance—any product or document that does not conform to the requirements (may include Component and/or Document non-conformance).

Request for Document/Procedure Change—any person who observes errors or omissions, discrepancies, ambiguous statements or incorrect data in any publication, or has suggestions for improvement to any publication.

Customer feedback—positive or negative, from internal or external sources.

Other reports

The system acts as the central repository for SMS data. Included in this is data collected in the form of reports, investigations and meeting records. This information and the occurrence reports are used to measure the effectiveness of the SMS, customer satisfaction, opportunities for continued improvement and to eliminate occurrences or the potential for occurrences.

Other types of reports include AOG Reports, Audit Report, Indexed Records (i.e. Risk Assessments, Safety Case Reports), Insurance Records, Meeting Records, Weekly SITREPS (weekly “situational reports” from the Bases), Investigations, Corrective Preventative Actions (CPA).

There are three types of CPA reports and investigations (INV):

a. CPA-A/INV—“Attached” CPA and INV: These are attached to a specific report i.e. an audit or an occurrence report. These are referred to as the “child” of the parent report. The parent report cannot be closed until all of the child reports are closed. These are often the result of a regulatory requirement.

b. CPA-L/INV—“Linked” to a report the parent report can be closed with the CPA still outstanding. This type of CPA or INV is usually considered an action item that is not a regulatory requirement.

c. CPA-S/INV—“Stand Alone” CPAs and INV: These are not attached to any parent report, and are a stand alone action item.

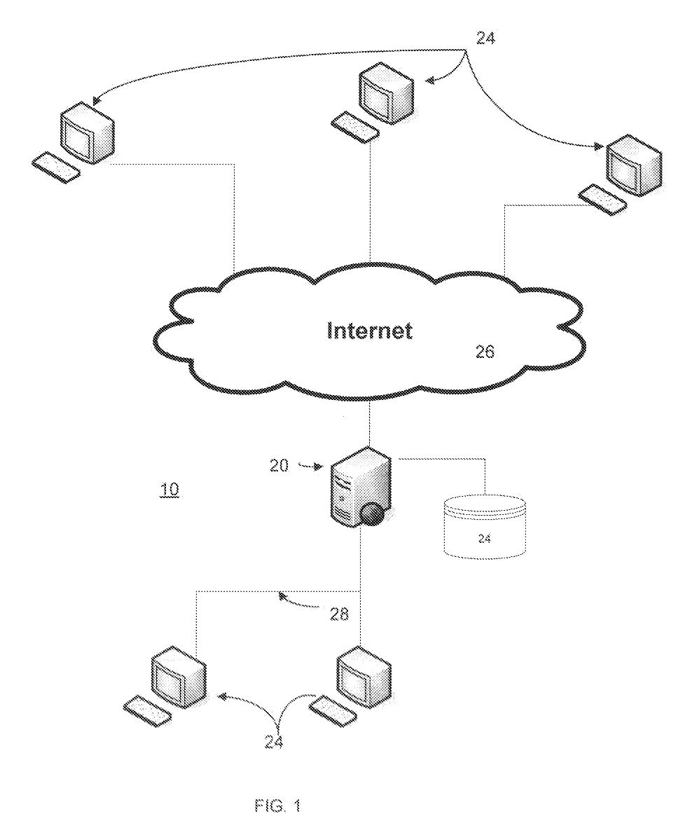

Referring now to FIG. 1, there is shown a general overview of one embodiment of an occurrence reporting system 10. The system 10 comprises a main or server computer 20 having conventional processing, data storage, input and output means and a database 22. The server computer 20 can be a unitary or a distributed system and is preferably a web server. Terminals 24 may be used by various employees, personnel and customers (collectively users) for access and communication via the Internet 26 or Intranet 28 with the server computer 20, each such user is initially authenticated and granted access to the occurrence reporting system in accordance with their role as determined by the system, and discussed later.

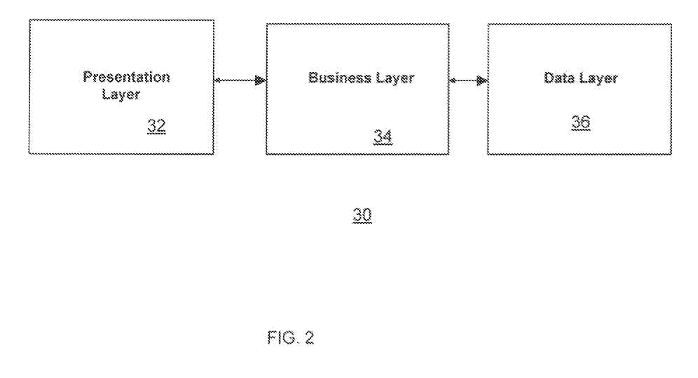

Users interact with the system 10 directly and are granted access based on their access roles. The web server 20 operates an occurrence reporting system 30 for collecting and collaborating on data collected in the form of reports, the reports including data related to one of more safety related occurrences in an enterprise, the system 30 includes three tiered architecture comprised of a presentation layer 32, business layer 34 and a data layer 36 as illustrated in the FIG. 2. The presentation layer comprises software modules for presenting the system 30 to users over the internet using https to be viewed in a web browser. The presentation layer produces the look and feel and manages the flow of the system 30. It also collects, filters and manage all user input (via https). All input and output from the presentation layer maybe encrypted via SSL encryption.

The business layer 34 contains the business logic of the system 30, exposed via a set of functions. By providing access to the business logic, this layer effectively acts as a broker—monitoring, controlling and managing all access to system data. Functions in the business layer are exposed to the presentation layer via encrypted XML Web Services using SOAP protocol.

The data layer 36 contains all of the system data in for example a SQL Server database 24. For security and performance reasons all data access may be through stored procedures. Stored procedures also effectively encapsulate data which will minimize the impact of any future changes to data structures. In a preferred embodiment each tier communicates using XML documents with pre-defined structures.

The Presentation layer is in turn comprised of four main sections. Namely, ‘User Authentication’, ‘Report entry and Management’, ‘Site Administration’ and ‘System Reporting’.

User Authentication

The presentation layer collects user credentials (such as username and password) and validates them against the corporate Active Directory via exposed functions in the business layer. In a preferred embodiment once validated, the presentation layer will store a user object representing the user in session. This object will persist until the user logs out of the system (or times out due to inactivity) and will inform the application as to the identity of the current user. That is, when an attempt is made to access any data or functionality of the application, the Presentation layer will ensure that a user object with the appropriate access rights is stored in session. If it is not, the system will redirect the user to a login page. To ensure the application is secure this user object will also contain information on the user's role and access rights. This information will be used by the presentation layer to determine what actions a user can perform and what data the user can view and/or edit.

Access to reports or documents in the system is assigned to a Role within the application. The individual assigned to that role may change. The new individual will have access to all the information previously available to the previous individual in that role, including specific confidential report. Confidential Reports remain the sole access of the original recipient.

Individuals who have an S&Q related role within the company are identified in that position matched to their individual names. The system will recognize an individual logging in as assigned to one or many roles. Individuals not identified as a “Role” in the system will have access at the lowest level: “General User.” The active directory entry for the employee will allow for the identification of the individual on communications such as system generated messages or system generated e-mails. A Role (e.g. Base Manager may be held by one or more individuals. Individuals who are party to the same Role will share the title but will have their own user ids and passwords. The Safety & Quality Manager is the “Owner” of all Occurrence Reports and their attachments (Pro- and Reactive). S/He may delegate their authority in the reporting system to a qualified individual. The company staff are given access to the system when they have been entered into the company active directory and assigned their respective position class as defined by a table of authorities.

General Access rules

Division personnel will be able to view sanitized reports of other divisions within their Company. Operational Divisions may authorize users to view the other's sanitized reports. Business Unit personnel will be able to view sanitized reports of other business units within their division. Base personnel (Roles) will be able to view sanitized reports of the bases within their Business Unit. Individuals will be able to view all information of reports they have originated. All the company/staff will have access to view all Summarized Reports.

Occurrence Report Entry and Management

One of the main functions of the system 30 is the input, output and processing of various types of reports. Specifically, the system manages the following reports:
Reactive Reports
   Flight Occurrence
   Ground Occurrence
   Customer Feedback
   Insurance Claim
   AOG (aircraft on ground)
Proactive Reports
   Non Conformance Documentation
   Non Conformance Components
   Hazard Identification
   Request for Document change(s)
Corrective Preventative Actions
Investigation
Audit Report
Indexed Report
Meeting
Weekly SITREP (Situational Report)
Confidential Report
Anonymous Report (Reference to external system)
   Additionally, some of these reports can contain different types of sub-reports including:
Bird Strike
Dangerous Goods
Airprox (Near Miss)
HESS (Health, Environment, Safety, Security)
Management of some reports may include the following other information: Summary
Preliminary Risk Rating
Upload Documents
Discussion
Investigations
Corrective Preventative Actions
Hazardous Events classification
Keywords
Human factors analysis and classification

To avoid overwhelming users with a mass of data, the presentation layer divides each of the reports listed above into sections. This increases the usability of the application by allowing users to enter and read reports in a more manageable fashion. An exemplary non exhaustive list of report sections used by the presentation layer are listed below:
Flight Occurrence
   Report Header
   Air Proximity
   Bird Strike
   Dangerous Goods
   Flight Information
   Document Upload
   HESS
   Keywords
   Preliminary Risk rating
   Summary
   Corrective Preventative Action
   Investigation
   Link Report
Ground Occurrence
   Report Header
   Ground Occurrence Info
   Document Upload
   HESS
   HFACS
   Keywords
   Preliminary Risk rating
   Summary
   Corrective Preventative Action
   Investigation
   Link Report
Insurance
   Report Header
   Insurance Info
   Document Upload
   Link Report
AOG

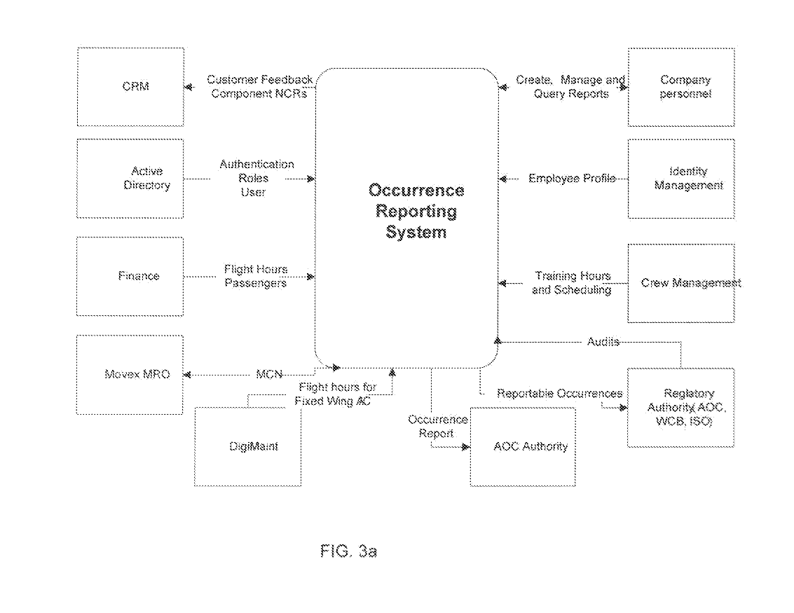

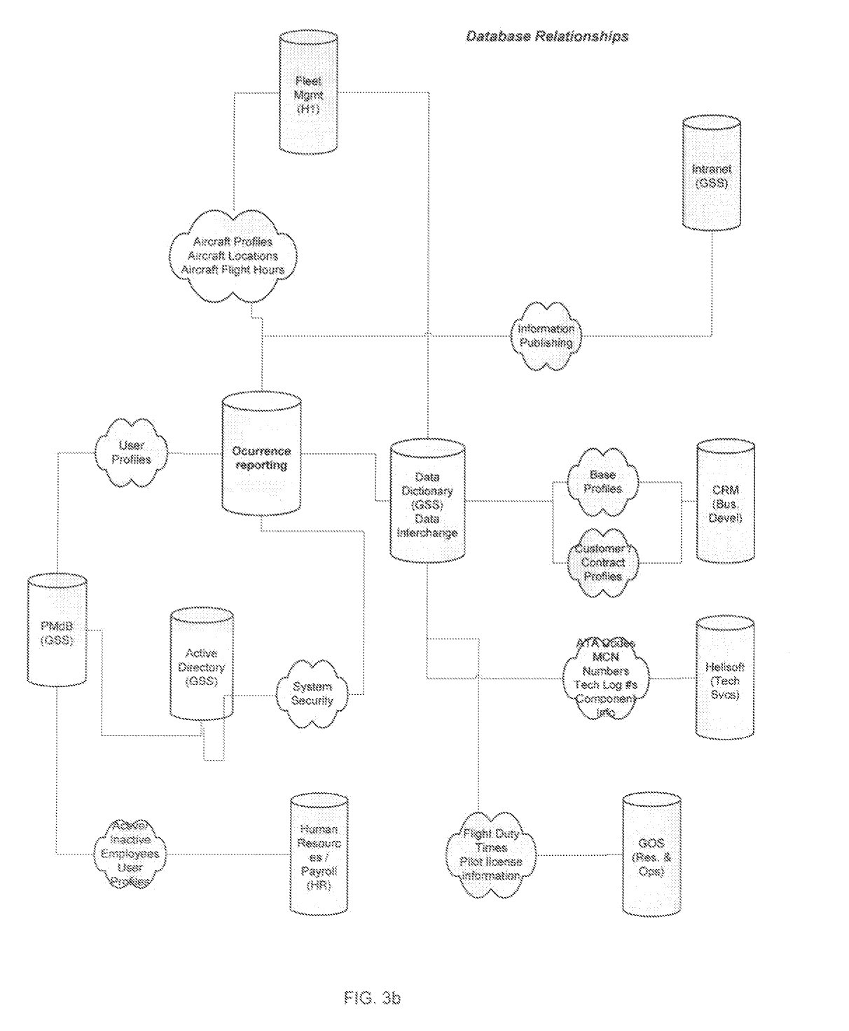

Referring to FIG. 3a there is shown a context diagram for the system 30 showing the interactions between the system 30 and external entities according to an embodiment of the present invention. FIG. 3b shows the equivalent database relationships. The system has three main functional areas:

Report Entry

A number of forms allow the collection of data reports in relation to occurrences and base events.

Report Management

After a report is entered it can be managed as necessary by the Business Unit S&Q Manager.

Query -Users with appropriate security will be able to search reports based on various criteria.

Each flow to and from the system is identified in the system context diagram of FIG. 3.

CRM (customer relationship manager)

The CRM entity accepts customer feedback for the company's global operations and non compliance reports for components.

Authentication

All users are authenticated and assigned security levels (Group assignment) via the active directory (AD). Username and Password are sent to the AD and a response includes successful logon and group assignment. If the user is currently authenticated the system will not prompt for an ID and password.

MCN

As part of the Non-Conformance—Component process MCN # from Movex MRO may be entered on the Non-Conformance report.

Training Hours and Scheduling

A Global Operations System provide Training Hours and Scheduling to provide system KPIs.

Employee Profile

The Identity Management System will manage User Profiles and Roles in the system.

Create Manage and Query Reports

The system manages the creation and management of reports from company employees. The system also provides KPIs and reporting. Various reports are created by the system and associated with a particular occurrence report. Division personnel will be able to view sanitized reports of other divisions within their Company. Operational Divisions authorize users to view the other's sanitized reports. Business Unit personnel will be able to view sanitized reports of other business units within their division. Base personnel (Roles) will be able to view sanitized reports of the bases within their Business Unit. Individuals will be able to view all information of reports they have originated. All the company staff will have access to view all Summarized Reports.

Audits

Usually regulatory authorities require regular audits to be completed on all operations of the company. Customer and internal audits may be in addition to these requirements.

Documentation

Events within the company will sometimes require reporting to external governing authorities (ISO, AOC, WCB)

AOC Authorities

Any reportable incident or accident will require specific reporting from the system. There are a significant number of AOC Authorities requiring different reporting formats.

Role of External Actors

The company employees will create reports within the system for all safety and quality issues.

Specific employees such as company managers will create and manage reports to ensure all safety and quality issues raised by employees are given appropriate attention. As mentioned earlier a “Role” is a person who has been set up with particular access in the system. This person may receive an assigned CPA, add comments to a discussion or be delegated a report to manage if they are not the default manager. A “General User” is a person who has no “role” in the system. They may not be delegated a report or receive an assigned CPA (they will not show on a list when a Report Manager delegates or assigns a CPA). The only function is to input an occurrence report and view their own report's progress. They may view ALL Summary reports that have been Updated (across all company divisions). Currently there are two types of “roles” in a user profile:

View Access (1 choice only). This allows the user to “see” to their level.

Report Management (may have many roles)

View Roles

In general, each user may view reports at one of the following levels:

Corporate: See across all Divisions

Division: See across all Business Units in their Division

Business Unit: See across all Bases in their Business Unit

Base: See their base

General User: See reports that have been originated by them.

The S&Q staff (Managers and Auditors) have their “View Access” role set at the Division level in order that they may best share information. The S&Q Manager's “Management” access is only to manage reports for their Business Unit.

Management Roles

A user may have multiple management roles if they manage reports for more than one Business Unit or Division

The system administrator has access to manage/edit and view all reports except confidential reports

Default Report Managers

Each report type has a default manager of that report type. Most reports may be delegated to another “Role”. A delegated report may be fully managed (assign CPA's, close) by the delegate. Reports are closed by the report manager or their assigned delegate.

All reports except Confidential and Anonymous may be delegated to anyone with a “Role” in the system.

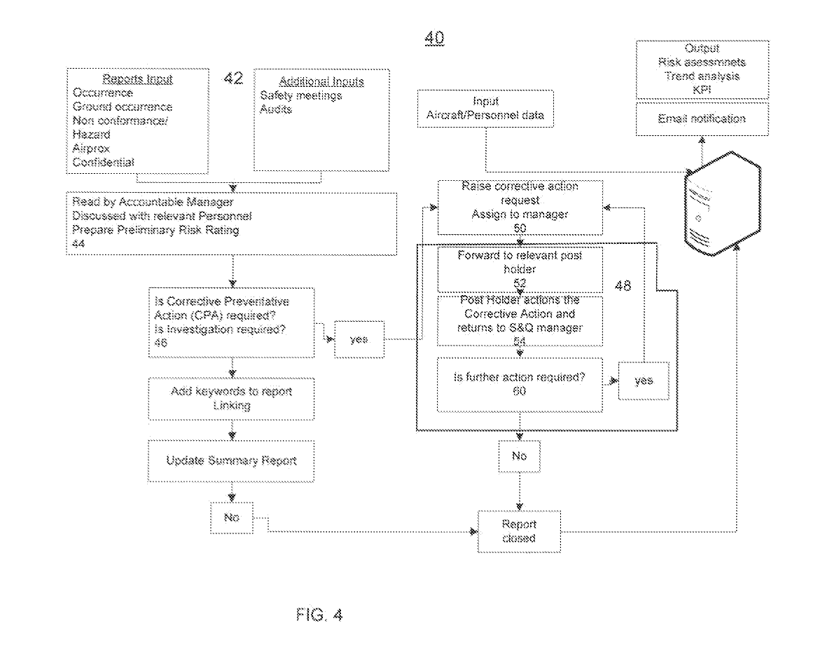

Referring to FIG. 4 there is shown a process 40 for handling an occurrence report according to an embodiment of the present invention. The process 40 begins at the step 42 with the report handling process at step 42 with the input of a specific type of report. As mentioned earlier, these reports are presented as a series of screens to the user and are generally classified in the accordance with the various types of occurrences that occur in the particular industry of interest. In the subject embodiment, this will be described in terms of the civil aviation industry. It may be noted that the occurrence reporting system of the present invention handles occurrence reports in accordance with the business rules of the organizations overall safety management systems and policies. These business rules may differ for different organisations and safety management systems. This flexibility derives in part from the multi-tiered architecture as described with reference to FIG. 2 earlier

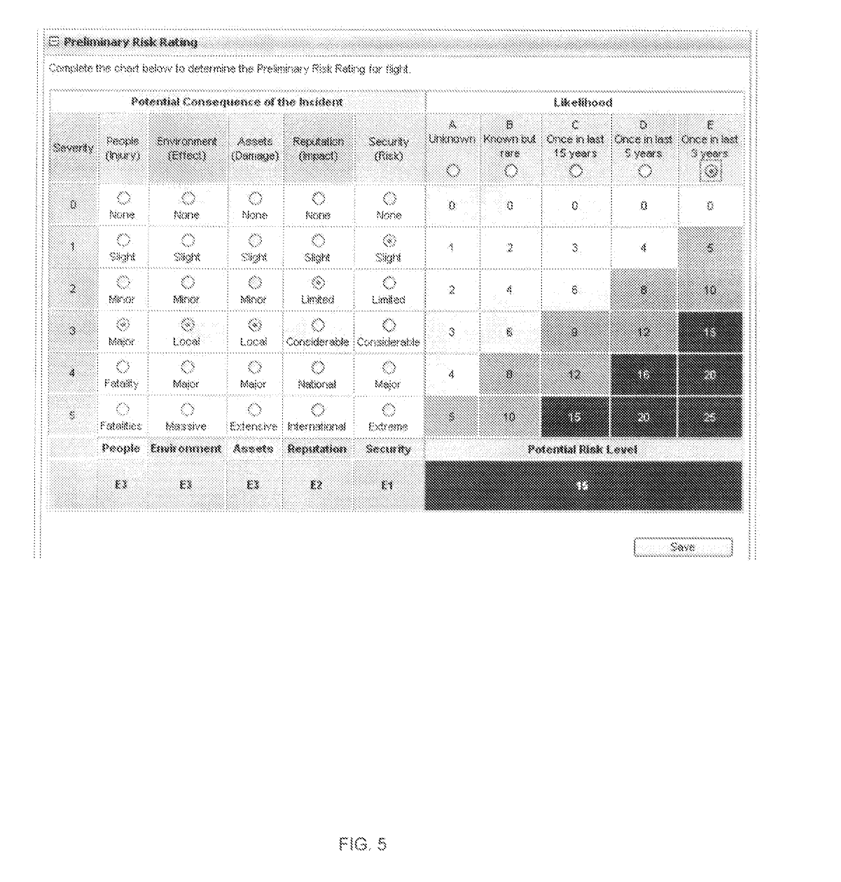

The data captured from the reports is stored in the database 24. The information captured by the reports depends on the type of occurrence being reported. Once a report is entered it is then available to be read at step 44 by an accountable manager. The appropriate accountable manager will vary depending on the type of report being inputted and on the particular business process. The accountable manager then discusses the report with the relevant personnel and a preliminary risk rating is done based on the type of occurrence being inputted. An example of a preliminary risk rating screen is shown in FIG. 5. At this time the accountable manager may assign to the report appropriate key words for trending and searching in effect a profile is created for the report, furthermore the report may be linked to other information such as other occurrence reports CPA's etc when required. Attachments may also be included with the report. If as shown in step 46 the report is either a CPA (Corrective Preventive Action required) or an investigation is required then the report is tagged by the system as being of a certain type and can't be closed until responded to. If the report indicates an investigation is required or it is a CPA then it follows process loop 48 and is assigned to a responsible manager at step 50. The responsible manager actions are corrective actions and returns to the accountable manager the report. This is achieved by recording details of the action taken and the completion date is also provided. At step 52 the accountable manager may determine whether the actions taken are suitable and also determine whether further action is required. If further action is required the process goes into a closed loop 48 where the report is returned to the responsible manager for further action. The entire process to this point and in fact for the entire subsequent process is visible to the author of the report although other individuals with different roles and unless authorized may not have access to see the entire process. One of the key aspects of this is that it allows the initiators of a report to follow the process and in fact believe that the report is being acted upon and not being ignored. Furthermore, if the author of the report decides that the action taken with regards to the report is insufficient a subsequent report linked to that report may be created by the author.

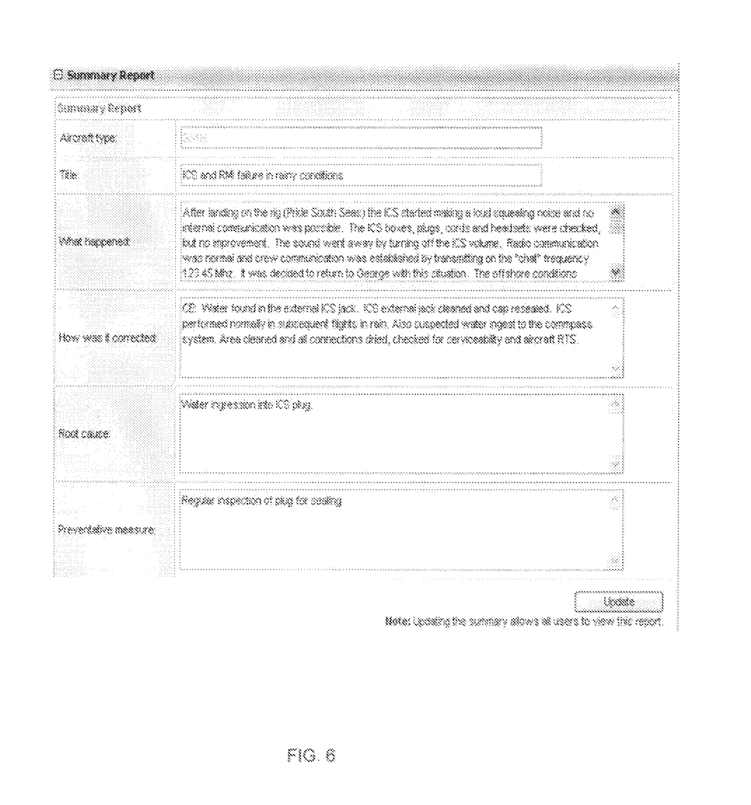

At step 60 if no further action is required then the CPA is closed or investigation is closed and an email notification with an embedded link is sent to the author informing them of the step. It may be mentioned that the step 42 when the report is created and a relevant accountable manager is designated the relevant accountable manager is also provided with an email informing them of the creation of an occurrence report. At step 64 reports are closed either after they have been acted upon or if no corrective action was required. Before a report is closed an update of a summary report, an example of which is shown in FIG. 6, is made and the summary report is available to all personnel further providing transparency to the process. Depending on the type of occurrence report the details of the action taken and the various steps and other actions taken are not necessarily provided in the summary report.

The database 24 is the central repository for all steps within the process which serves two purposes one is that the information can be used for trend analysis, key performance indicators and to share best practices. A further advantage is that it provides a detailed order trail of the entire process. In addition to occurrence reports being inputted a further type of occurrence report will be an ordered report which is also stored in the database and is accessible to designated users again depending on their roles within the company.

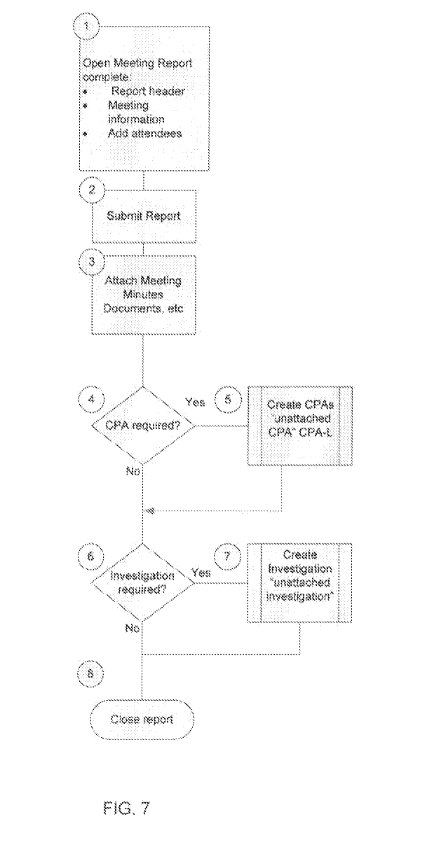

Referring to FIG. 7 there is shown a process for recording a meeting in the occurrence reporting system 30 of the present invention. Meetings are one of the methods used by the organization to communicate safety concerns and suggest improvements to their SMS. As meetings are part of the SMS review and continuous improvement cycle they are tracked and monitored for frequency and action required such as CPAs and Investigations. The type and frequency of meetings is collected as part of the “detailed SMS statistical report” used by management to monitor the effectiveness of the SMS and the accomplishment targets and goals.

The various steps in FIG. 7 are described as follows: 1. The individual that opens the meeting report becomes the report manager. 2. The report must be “Submitted” to allow for attaching documents, CPAs or investigation. 3. Attach to the meeting record any pertinent documents, meeting agenda, meeting minutes, reports or documents presented or discussed during the meeting. 4. & 5. Determine if CPAs are required to address the action items arising from the meeting. Open “unattached” or linked CPAs to the meeting report 6. & 7. If one of the action items arising from the meetings requires investigation open an “Unattached investigation”. It is the responsibility of the Report Manager to notify the Regional Director, Safety and Quality Manager of the Business Unit affected and any individuals responsible for initiating CA/PA or an investigation as a result of the meeting. 8. The report manager is responsible to close the report in the “update status to” box on the report. The meeting report can be closed with open CPAs or investigations linked to the report.

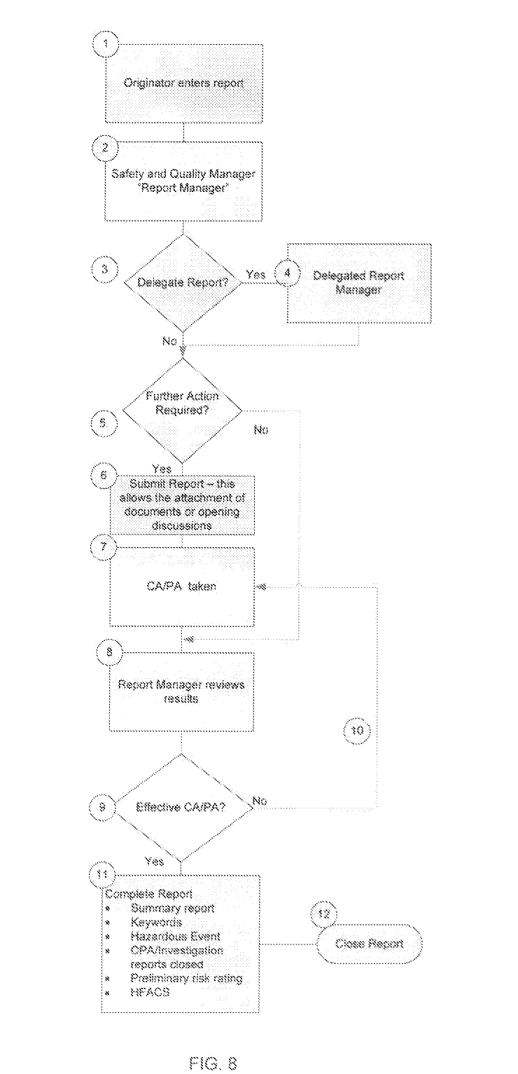

Referring to FIG. 8 there is shown a flowchart according to another embodiment of the invention which describes the actions taken when and occurrence is reported using the system 30. This process is applicable to all occurrence reports with the exception of “Customer Feedback” occurrences and confidential reports which are addressed later.

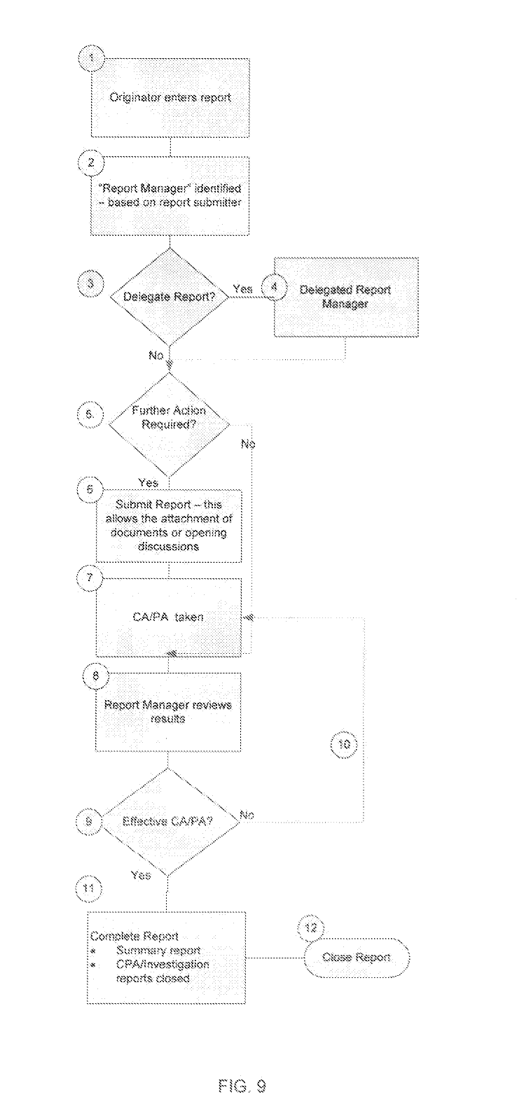

Referring now to FIG. 9 there is shown a flowchart illustrating how customer feedback reports are captured are specifically designed for positive and negative feedback from a customer to whom a service or product is provided. The reporting of Customer Feedback is administered the same as occurrence reports however the Report Manager for Customer Feedback Reports is dependant on the recipient of the feedback occurrence.

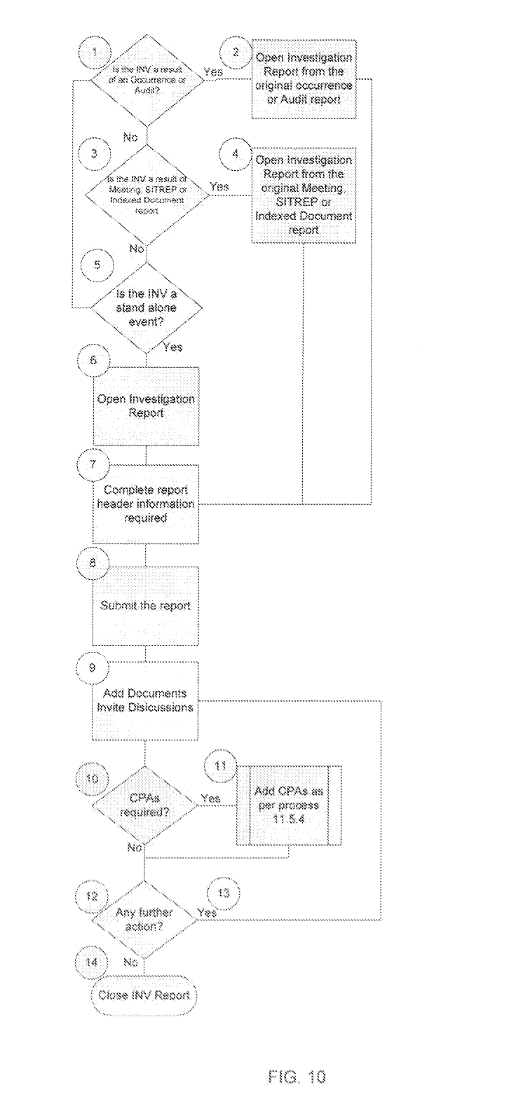

Referring to FIG. 10 there is shown a flowchart of how investigations are reported. The requirement for an investigation can came be as a result of an occurrence or an audit. Where an investigation is required after an occurrence or an audit the investigation report is opened from occurrence or audit report. This type of investigation is considered an “attached investigation”. A report that has an investigation attached cannot be closed until the attached investigation is closed. When an investigation is required due to an item identified in a meeting, indexed document, meeting or a SITREP report it is a linked investigation. A report that has an investigation linked may be closed while the investigation remains open.

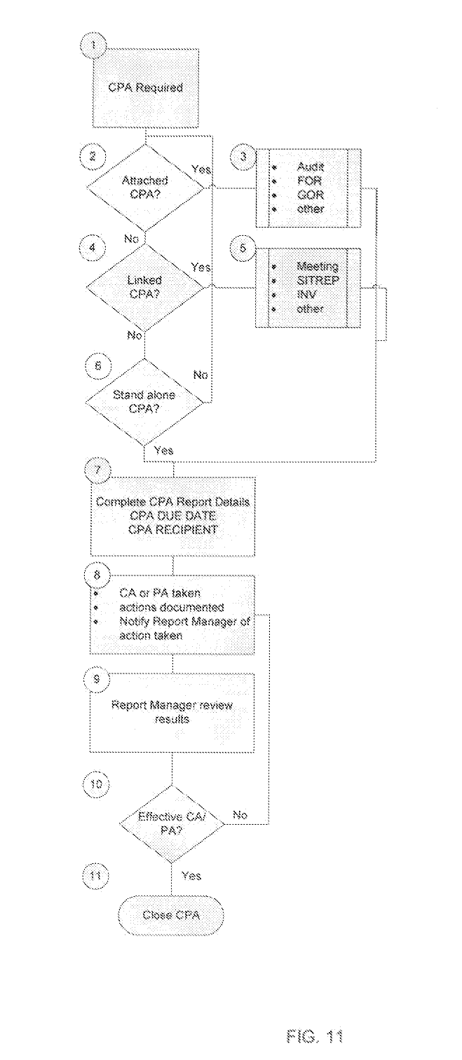

Referring to FIG. 11 there is shown a process when it has been determined that a corrective and preventative action is required to correct the occurrence or prevent reoccurrence these actions are tracked through the system by raising a CPA report. Individuals that are designated a “Management Role” in the system are able to raise a CPA. The person who raises the CPA is the Report Manager. The Report Manager may delegate the CPA.

There are three types of CPA reports that can be raised

CPA-A—Attached CPA: Where the requirement for further action is a result of an occurrence, or an audit an attached CPA should be raised. This means that report to which a CPA is attached (parent report) cannot be closed until all of the attached CPA are closed.

CPA- L—Linked CPA: Where the requirement for further action is a result of an investigation, meeting record or SITREP a linked CPA shall be raised. Linked CPA can remain open while the report to which they are linked (parent report) may be closed.

CPA-S—Stand Alone CPA: This type of CPA is a stand alone report. It has no parent report. A stand alone CPA can be raised for an observation or event that needs further action to correct the situation or prevent it form happening.

The following information is required to raise a CPA:

Include a brief description of the situation or event that needs corrective or preventative action in the “Description of CPA” block.

Corrective action that has been taken (if any)

Recommended preventative action (optional)

Root cause (optional)

Long term preventative action (optional)

CPA-A due date should be entered as 30 working days from the date the CPA-A is raised. CPA-L and CPA-S due date are at the discretion of the Report Manager

Re-audit (as required)

CPA recipient—it is important the recipient be an individual that can accomplish effective corrective or preventative action, or is responsible to ensure corrective and preventative action occurs.

Include a document reference to which the non-compliance relates (where applicable).

Include a Regulatory Authority document reference to which the non-compliance relates (where applicable).

Corrective or preventative action taken is documented in the appropriate box under management data. When an action has been taken the CPA recipient will notify the Report Manager. The Report Manager reviews the actions taken to ensure they are effective and when satisfied closes the CPA.

When the Investigation (INV) report is opened the Report Manager must notify Regional Director and Safety and Quality Manager of the effected business unit, and any individuals tasked with initiating all or part of the investigation or CA/PA. The report must be “Submitted” to allow for attaching documents, CPAs or to invite individuals to discussions. Attach to the INV report (“document” tab) any pertinent documents, meeting minutes, reports or evidence presented or discussed during the meeting, or invite individuals to a discussion. If there are items that require further action the INV report should remain open. If all aspects of the investigation are complete then the report can be closed.

In summary the present system provides occurrence reporting for both reports entered into the system (inbound) and reports to regulatory bodies (outbound); tracking of corrective and preventative action taken on a particular occurrence report; data collection and trend analysis and reporting of S&Q related data; audit management and a communication tool between Post Holders/Accountable Managers, S&Q Staff and Regional Directors.

While certain features of the matter have been illustrated as described herein, many modifications, substitutions, changes and equivalents will now occur to those skilled in the art. It is, therefore, to be understood that the appended claims are intended to cover all such embodiments and changes as fall within the true spirit of the matter.

We claim:

1. A method for implementing an occurrence reporting tool for use in a safety management system, the method comprising the steps of:
a. inputting at least one safety related occurrence;
b. determining whether said input occurrence requires corrective action;
c. generating a request for corrective action if said occurrence is determined to require corrective action; and
d. continuing to generate said request for corrective action until appropriate corrective action is taken.
